(19) United States
(12) Patent Application Publication
(10) Pub. No.: US 2026/0169474 A1
(43) Pub. Date: Jun. 18, 2026

(54) METHOD AND APPARATUS FOR RECOGNIZING PARKING SITUATIONS

(71) Applicants: HYUNDAI MOTOR COMPANY, Seoul (KR); KIA CORPORATION, Seoul (KR)

(72) Inventors: Sung Yeon Kim, Hwaseong-si (KR); Eun Seok Jung, Hwaseong-si (KR)

(73) Assignees: HYUNDAI MOTOR COMPANY, Seoul (KR); KIA CORPORATION, Seoul (KR)

(21) Appl. No.: 19/374,552

(22) Filed: Oct. 30, 2025

(30) Foreign Application Priority Data
Dec. 17, 2024 (KR) 10-2024-0188954

(51) Int. Cl. G05D 1/222; G01S 15/931; G05D 107/13; G05D 109/10; G05D 111/20

(52) U.S. Cl. CPC G05D 1/222; G01S 15/931; G01S 2015/932; G05D 2107/13; G05D 2109/10; G05D 2111/20

(57) ABSTRACT

A method of recognizing a parking situation includes: monitoring a parking situation of a vehicle; determining whether the vehicle enters a parking space; determining whether the vehicle is intended to align with the parking space when the vehicle enters the parking space; determining whether the vehicle has completed an alignment with the parking space upon determining that the vehicle is intended to align with the parking space; determining whether the vehicle leaves the parking space when determining that the vehicle has completed the alignment with the parking space; determining presence of an obstacle around the vehicle using a sensor when determining that the vehicle has not left the parking space; and activating a remote control mode of the vehicle when determining that the vehicle has not left the parking space.

### CROSS-REFERENCE TO RELATED APPLICATION

This application claims the benefit of and priority to Korean Patent Application No. 10-2024-0188954, filed on Dec. 17, 2024, the entire contents of which are hereby incorporated herein by reference in its entirety.

### TECHNICAL FIELD

The present disclosure relates to a method and an apparatus for recognizing parking situations.

### BACKGROUND

The content described below merely provides background information related to the present embodiment and does not constitute prior art.

Autonomous parking is an autonomous driving technology. Autonomous parking is a technology of controlling a vehicle such that the vehicle parks itself in a designated parking space. Remote smart parking assist (RSPA) is a method of performing autonomous parking. The RSPA provides convenience to a driver and a passenger in places where it is difficult to get in and alight from a vehicle, such as narrow parking spaces, by allowing the vehicle to park itself using a smart key from outside the vehicle. The RSPA includes a method of autonomously parking in a designated parking space based on an ultrasonic sensor (RSPA) and a method of autonomously parking based on a surround view monitor (SVM) camera (RSPA 2).

A camera can clearly identify whether an object present around a vehicle is a person, a vehicle, or an object. On the other hand, ultrasound can detect objects around a vehicle, but the detection distance is short, and objects cannot be accurately identified. Because the RSPA 2 performs autonomous parking based on camera images, it is easier to identify parking spaces and obstacles around a vehicle than the RSPA, which performs autonomous parking based on ultrasound. The RSPA 2, which easily identifies parking spaces and obstacles, can perform autonomous parking more safely than the RSPA.

However, the current autonomous parking technology has some usability issues. First, there is a lack of usability in entering the remote forward/backward function at the time of parking a vehicle in a narrow space. When a driver attempts to park in a narrow space, there are cases where it is difficult to activate the remote forward/backward function and thus the user experience inconvenience. For example, a driver often turns off the engine immediately before parking and tries to activate the remote forward/backward function after remotely starting the engine. In the current specifications, in order to activate the remote forward/backward function while the drive is driving, it is necessary to perform gear shifting and button operation. Furthermore, the method of entering the remote forward/backward function while driving is provided in the form of a pop-up on a camera screen, but the driver often ignores or does not recognize the guidance because the user focuses on checking the camera screen around the vehicle.

Second, there is a situation in which it is impossible to get out of a narrow reverse perpendicular parking space by using the RSPA 2. When the smart parking mode of the RSPA 2 (which is operated while the driver is on board) is executed in a perpendicular parking space where there is a vehicle or a pillar on the driver's side, even if the function is terminated after parking is completed, a situation in which the driver cannot open the door may occur. In such cases, there is the inconvenience of having to separately activate the remote forward/backward function or re-align the vehicle. In the current specifications, if the driver alights from the vehicle while holding the smart key, it is possible to switch to a remote parking mode once, but it is difficult to predict in advance the situation in which an obstacle is close enough to prevent the door from being opened.

Such problems hinder user experience of autonomous parking technology, and particularly, additional technical solutions are required to improve driver convenience and safety in narrow parking spaces.

### SUMMARY

An object of the present disclosure aims to provide convenience and efficiency to a driver by actively suggesting a remote parking function and minimizing the operation process in a parking situation in which it is difficult for the driver or passengers to alight from the vehicle.

An object of the present disclosure is to correctly recognize that a vehicle has entered a perpendicular or angle parking situation and to suggest a remote control mode to a driver when an obstacle around the vehicle is detected before parking is completed.

The objects to be achieved by the present disclosure are not limited to the objects mentioned above, and other objects that are not mentioned should be clearly understood by those having ordinary skill in the art from the present disclosure.

An embodiment of the present disclosure provides a method of recognizing a parking situation including monitoring a parking situation of a vehicle. The method further includes determining whether the vehicle enters a parking space. The method further includes determining whether the vehicle is intended to align with the parking space when the vehicle enters the parking space. The method further includes determining whether the vehicle has completed an alignment with the parking space when determining that the vehicle is intended to align with the parking space. The method further includes determining whether the vehicle leaves the parking space when determining that the vehicle has completed the alignment with the parking space. The method further includes determining presence of an obstacle around the vehicle using a sensor when determining that the vehicle has not left the parking space. The method further includes activating a remote control mode of the vehicle when determining that the vehicle has not left the parking space.

Another embodiment of the present disclosure provides an apparatus including at least one memory configured to store instructions and including at least one processor. The at least one processor is configured, by executing the instructions, to monitor a parking situation of a vehicle. The at least one processor is further configured to determine whether the vehicle enters a parking space. The at least one processor is further configured to determine whether the vehicle is intended to align with the parking space when the vehicle enters the parking space. The at least one processor is further configured to determine whether the vehicle has completed an alignment with the parking space when determining that the vehicle is intended to align with the parking space. The at least one processor is further configured to determine whether the vehicle leaves the parking space when determining that the vehicle has completed the alignment with the parking space. The at least one processor is further configured to determine presence of an obstacle around the vehicle using a sensor when determining that the vehicle has not left the parking space The at least one processor is further configured to activate a remote control mode of the vehicle when determining that the vehicle has not left the parking space.

According to an embodiment of the present disclosure, it is possible to provide convenience to a driver by improving accessibility of a remote control mode in a narrow perpendicular parking area.

According to an embodiment of the present disclosure, when parking is performed using remote smart parking assist based on a surround view monitor (SVM) camera (RSPA 2) in a narrow perpendicular parking area, it is possible to solve problems due to an insufficient space for alighting by supporting a remote control mode function after smart parking is completed.

According to an embodiment of the present disclosure, it is possible to effectively recognize parking situations between vehicles without having parking lines or perpendicular parking situations in low-illuminance environments at night.

The effects of the present disclosure are not limited to the effects mentioned above, and other effects that are not mentioned should be clearly understood by those having ordinary skill in the art from the description below.

### BRIEF DESCRIPTION OF THE DRAWINGS

FIG. 1 is a diagram showing a connection state between a vehicle and a driver terminal according to an embodiment of the present disclosure.

FIG. 2 is a block diagram showing a vehicle according to an embodiment of the present disclosure.

FIG. 3 is a block diagram showing a control device according to an embodiment of the present disclosure.

FIG. 4 is a flowchart showing an operation process of the control device according to an embodiment of the present disclosure.

FIGS. 5A, 5B, and 5C are diagrams showing examples recognized as parking situations by a parking control unit according to an embodiment of the present disclosure.

FIGS. 6A, 6B, and 6C are diagrams showing examples that are not recognized as parking situations by the parking control unit according to an embodiment of the present disclosure.

FIG. 7 is a block diagram schematically showing a computing device that can be used to implement a method or an apparatus according to the present disclosure.

### DETAILED DESCRIPTION

Hereinafter, some embodiments of the present disclosure are described in detail with reference to the accompanying drawings. In the present disclosure, like reference numerals designate like elements, although the elements are shown in different drawings. Further, in the present disclosure, a detailed description of known functions and configurations incorporated therein has been omitted for the purpose of clarity and for brevity.

Additionally, various terms such as first, second, A, B, (a), (b), etc., are used solely to differentiate one component from the other but not to imply or suggest the substances, order, or sequence of the components. Throughout the present disclosure, when a part ‘includes’ or ‘comprises’ a component, the part is meant to further include other components and is not intended to exclude thereof unless specifically stated to the contrary. The terms such as ‘unit’, ‘module’, and the like refer to one or more units for processing at least one function or operation, which may be implemented by hardware, software, or a combination thereof. When a controller, unit, module, component, device, element, or the like of the present disclosure is described as having a purpose or performing an operation, function, or the like, the controller, unit, module, component, device, element, or the like should be considered herein as being “configured to” meet that purpose or to perform that operation or function. Each controller, unit, module, component, device, element, and the like may separately embody or be included with a processor and a memory, such as a non-transitory computer readable media, as part of the apparatus.

The following detailed description, together with the accompanying drawings, is intended to describe embodiments of the present disclosure and is not intended to represent the only embodiments in which the present disclosure may be practiced.

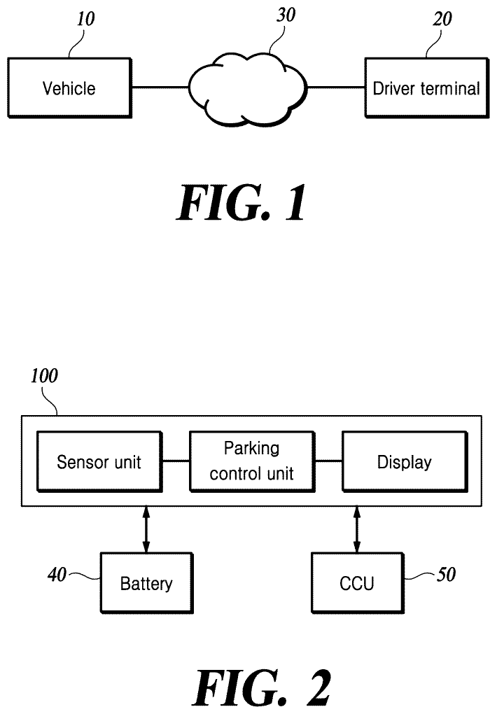

FIG. 1 is a diagram showing a connection state between a vehicle 10 and a driver terminal 20 according to an embodiment of the present disclosure.

Referring to FIG. 1, the vehicle 10 includes an electric vehicle (EV) but is not limited to a specific type of vehicle and may include various vehicle types, such as an internal combustion engine vehicle or a hybrid vehicle.

The driver terminal 20 may access various functions of the vehicle and remotely transmit driver's commands to the vehicle 10. The driver terminal 20 includes a smart key and may be implemented as a smartphone application or a remote control device as needed. The driver can monitor the parking state of the vehicle 10 and can transmit control commands by using a remote control application of the driver terminal 20.

A network 30 connects the vehicle 10 and the driver terminal 20 and may be a closed network, such as a local area network (LAN) or a wide area network (WAN), or an open network, such as the Internet. Here, the Internet refers to a worldwide open computer network structure that provides various services present in the TCP/IP protocol and upper layers thereof, i.e., HyperText Transfer Protocol (HTTP), Telnet, File Transfer Protocol (FTP), Domain Name System (DNS), Simple Mail Transfer Protocol (SMTP), Simple Network Management Protocol (SNMP), Network File Service (NFS), and Network Information Service (NIS).

FIG. 2 is a block diagram showing the vehicle 10 according to an embodiment of the present disclosure.

Referring to FIG. 2, the vehicle 10 may include all or some of a battery 40, a communication control unit (CCU) 50, and an autonomous parking control device (hereinafter, referred to as a “control device” 100). The components shown in FIG. 2 represent functionally distinguished elements, and one or more components may be integrated in an actual physical environment.

The battery 40 can supply power for the operations of electrical parts in the vehicle 10 and may supply power through at least one power output terminal. For example, the B+ terminal of the main battery 40 may be connected to the control device 100, and 12 V operating power can be supplied through the B+ terminal.

The CCU 50 is a wired and wireless communication integrated controller for a function of connecting with the inside and outside of the vehicle and data transmission. The CCU 50 may provide wireless software update and driving experiences, such as vehicle data collection and remote diagnosis. In addition, the CCU 50 may transmit/receive signals to/from remote control applications. Here, the remote control applications may include, but are not limited to, bluelink, Kia Connected, and My Genesis.

The control device 100 determines whether the vehicle 10 is parked based on driving data of the vehicle 10. Upon detection of an obstacle using an ultrasonic sensor provided on the side of the vehicle 10, the control device 100 may actively suggest an appropriate remote parking function to the driver. The control device 100 checks whether there is an obstacle that may hinder the driver or a front passenger from alighting. If it is not easy for the passenger to alight, the control device 100 supports the driver to use a remote parking function without performing an additional complicated operation. Therefore, the control device 100 can assist the driver to perform parking and alighting more efficiently and safely. The control device 100 is linked with various sensors and the CCU 50 inside the vehicle 10 and can exchange data in real time through communication with the driver terminal 20. In this process, the control device 100 comprehensively analyzes the vehicle and surrounding situations to contribute to improving the driver's experience.

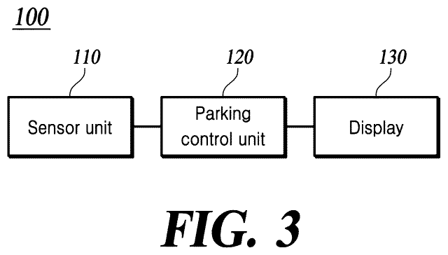

FIG. 3 is a block diagram showing the control device 100 according to an embodiment of the present disclosure. FIG. 1 may also be referred to in order to explain FIG. 3.

Referring to FIG. 3, the control device 100 may include all or some of a sensor unit 110, a parking control unit 120, and a display 130. The components shown in FIG. 3 represent functionally distinguished elements, and one or more components may be integrated an actual physical environment.

The sensor unit 110 may include various types of sensors to collect driving data and surrounding environment data. For example, the sensor unit 110 may include a steering wheel angle sensor, an ultrasonic sensor, a Time-of-Flight (TOF) sensor, a radar sensor, a speed sensor, a camera sensor, etc.

The sensor unit 110 collects driving data and surrounding environment data of the vehicle 10. Here, the driving data may include at least one of a steering wheel operation angle, a shifting direction, or a vehicle speed. The steering wheel operation angle is a value indicating a degree to which the driver turns the steering wheel to change the direction of the vehicle 10. For example, if the driver turns the steering wheel to the right, the steering wheel operation angle is measured as a positive (+) angle. If the driver turns the steering wheel to the left, the steering wheel operation angle is measured as a negative (−) angle.

The parking control unit 120 may include at least one of a cluster unit (CLU) controller, an engine control unit (ECU) controller, an electronic stability control (ESC) controller, an anti-lock brake system (ABS) controller, a body control unit (BCU) controller, a smart junction box (SJB), or a smart key (SMK) controller.

The parking control unit 120 analyzes data received from the sensor unit 110 to monitor whether the vehicle 10 is currently parked or is traveling. In other words, the parking control unit 120 recognizes that a parking situation is occurring when the operation of the driver or remote smart parking assist based on a surround view monitor (SVM) camera (RSPA 2) satisfies specific conditions. To this end, the parking control unit 120 may analyze a movement pattern of the vehicle 10 by preprocessing data such as the steering wheel operation angle, gear shifting, and vehicle speed and may recognize a parking situation. Here, the specific conditions may include a condition in which the vehicle 10 enters a parking space at a low speed, a condition in which the vehicle 10 aligns the direction thereof with the direction of the parking space to enter the parking space, and a condition in which the vehicle enters the parking space after completing alignment. Parking situations may include, but are not limited to, perpendicular parking, parallel parking, and angle parking. For example, if a large steering operation and a change in gear status are detected at a low speed, the parking control unit 120 may determine that the vehicle 10 is about to enter a parking space.

The parking control unit 120 determines that it is difficult for the driver to alight when the distance between the vehicle and an obstacle is equal to or less than a specific value, and the parking control unit 120 suggests a remote control mode. The remote control mode can be executed by the driver using a smart key or a smartphone application. In the remote control mode, various functions including a remote parking function can be performed.

The display 130 displays a remote control screen configured by the parking control unit 120. The display 130 intuitively and visually provides a parking status and remote control mode suggestion UX. The display 130 may also be used as an input device that can receive user input for selecting a function button included in the remote control screen. The display 130 may be implemented in the form of a touchscreen including a touch sensor such as a touch film or a touch pad.

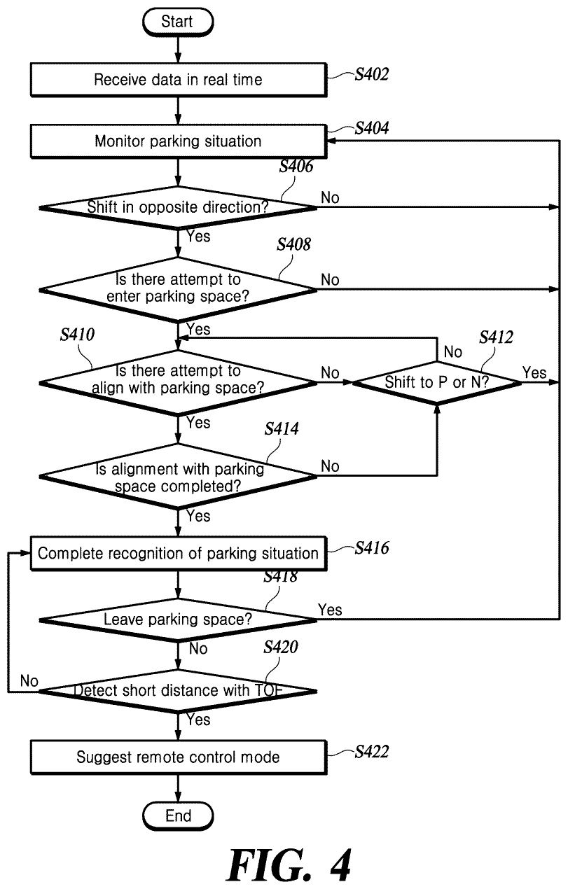

FIG. 4 is a flowchart showing an operation process of the control device 110 according to an embodiment of the present disclosure.

The sensor unit 110 receives driving data of the vehicle 10 and surrounding environment data in real time (S402). Here, the driving data may include at least one of a steering wheel operation angle, a shift direction, or a vehicle speed.

The parking control unit 120 analyzes data received from the sensor unit 110 to monitor whether the vehicle 10 is currently parked or traveling (S404). The parking control unit 120 analyzes the movement pattern of the vehicle 10 by preprocessing data, such as the steering wheel operation angle, gear shifting, and vehicle speed, and recognizes a specific parking situation. Here, the specific parking situation includes, but is not limited to, perpendicular parking, parallel parking, and angle parking.

The parking control unit 120 determines whether shifting is performed in the opposite direction (S406). Shifting in the opposite direction is determined by comparing the previous gear and the current gear. In other words, if the previous gear is D (drive) and the current gear is R (reverse), or if the previous gear is R and the current gear is D, the parking control unit 120 determines shifting in the opposite direction. If shifting in the opposite direction is not determined (S406—NO), monitoring step S404 is performed.

Upon determining shifting in the opposite direction (S406—YES), the parking control unit 120 determines whether the vehicle 10 is intended to enter a parking space (S408). The parking control unit 120 analyzes the statuses of the previous gear and the current gear based on the data collected from the sensor unit 110. First, the parking control unit 120 checks whether the vehicle 10 maintains a low speed state and the steering wheel operation angle exceeds, for example, ±270 degrees in one direction in the previous gear. Here, maintaining a low speed state means that the vehicle maintains a speed at or below 10 km/h. The steering wheel operation angle means a physical operation in which the user directly turns the steering wheel, and exceeding ±270 degrees means that the steering wheel is rotated more than 270 degrees to the left or more than 270 degrees to the right. If the vehicle 10 maintains a low speed state and the steering wheel operation angle exceeds ±270 degrees in one direction, the parking control unit 120 determines that the vehicle 10 is entering a parking space. If it is not determined that the vehicle 10 is entering a parking space (S408—NO), monitoring step S404 is performed.

If it is determined that the vehicle 10 is entering a parking space (S408—YES), the parking control unit 120 determines whether the vehicle 10 is intended to align itself within the parking space in the current gear (S410). In other words, the parking control unit 120 determines whether the vehicle 10 turns the steering wheel in the opposite direction to align itself with the parking space. Upon detecting a steering wheel operation exceeding, for example, ±180 degrees in the current gear, the parking control unit 120 determines that the vehicle 10 is intended to align itself with the parking space. Here, the steering wheel operation needs to be in the opposite direction to the steering wheel operation exceeding ±270 degrees in the previous gear. For example, while the vehicle 10 is entering the parking space after shifted to R gear, the parking control unit 120 checks whether the vehicle 10 is shifted to D gear and turns the steering wheel in the opposite direction to the direction in which the steering wheel is turned when the vehicle 10 enters the parking space.

If it is determined that there is no intention to align within a parking space (S410—NO), the parking control unit 120 determines whether there is an additional shift (S412). In other words, if it is determined that there is no intention to align within a parking space, when shifting to P or N gear is performed (S412—YES), all processes are initialized and the parking control unit 120 returns to the step of monitoring a parking situation (S404). On the other hand, when shifting to D or R gear is performed (S412—NO), the parking control unit 120 determines whether there is an attempt to align within a parking space again.

If it is determined that there is an intention to align within a parking space (S410—YES), the parking control unit 120 determines whether the vehicle 10 has completed alignment within the parking space (S414). The parking control unit 120 determines whether the vehicle 10 has completed alignment within the parking space based on the steering state and travel distance of the vehicle 10. When the vehicle 10 maintains a narrow steering wheel angle and moves forward or backward a certain distance, the parking control unit 120 determines that the vehicle 10 has completed alignment with the parking space. Here, the narrow steering wheel angle means a state in which the steering wheel operation angle is maintained at, for example, ±45 degrees or less. The certain distance means that the vehicle 10 moves forward or backward by, for example, 0.5 meters or more.

If it is determined that alignment within the parking space is not completed (S414—NO), the parking control unit 120 determines whether there is an additional shift. In other words, if it is determined that alignment within the parking space is not completed (S414—NO), the parking control unit 120 returns to the step of monitoring a parking situation (S404) when shifting to P or N gear is performed (S412—YES). On the other hand, if shifting to D or R gear is performed (S412—NO), the parking control unit 120 determines again whether alignment within the parking space is completed.

If it is determined that the vehicle 10 has completed alignment within the parking space (S414—YES), the parking control unit 120 recognizes the current situation of the vehicle 10 as a parking situation (S416). Thereafter, the parking control unit 120 determines whether the vehicle 10 has left the parking space (S418). For determination, after the alignment within the parking space is completed, it is determined whether a sudden steering wheel operation has occurred in the vehicle 10. A sudden steering wheel operation means a case in which the steering wheel operation angle exceeds, for example, ±180 degrees. If a sudden steering wheel operation is detected, the parking control unit 120 determines that the vehicle 10 is intended to leave the parking space (S418—YES) and returns to the step of monitoring a parking situation (S404).

If it is determined that the vehicle 10 has not left the parking space (S418—NO), the parking control unit 120 monitors the direction of travel and the lateral area of the vehicle 10 by using an ultrasonic sensor or a TOF sensor. The parking control unit 120 detects the distance between the vehicle 10 and surrounding obstacles using TOF sensors on the driver's side and the passenger's side and determines whether an obstacle is present within a certain distance, for example, 0.5 meters (S420). Therefore, the parking control unit 120 can optimize the parking state of the vehicle 10 and prevent potential collisions by continuously checking the surrounding environment while the vehicle 10 is moving or maintaining alignment within the parking space.

If an obstacle is detected by the TOF sensor on the driver's side or the passenger's side (S420—YES), the parking control unit 120 determines that there is an object around the vehicle. Before the door on the driver side reaches a certain distance from the location where the obstacle is present, the parking control unit 120 may suggest a remote control mode to the driver (S422). In other words, the parking control unit 120 may provide visual feedback to the driver by conveying the content displayed on the CLU to the driver. Then, when the driver alights from the vehicle 10 while holding the smart key, the parking control unit 120 activates the remote control mode.

For example, if the driver opens the door in a situation in which the vehicle 10 completes alignment within the parking space and reverses to complete parking, the gear is automatically shifted to P as soon as the door opens. The CLU displays a guidance message saying, “For convenient alighting, the remote forward/backward function will be executed when alighting with the smart key”. Therefore, the driver can alight and complete parking remotely using the smart key or a smartphone.

In another example, if the driver stops the vehicle 10 at a location that is not suitable for alighting, the parking control unit 120 maintains the remote control mode such that the vehicle moves to a location where the driver can alight. The CLU displays a message guiding the driver to move to a location where the driver can alight, and the driver can alight from the vehicle while holding the smart key or the smartphone and can use the remote control mode to move the vehicle to an appropriate location. In this process, the driver can operate the vehicle such that the vehicle reverses to enter a parking space by inputting a reverse button of the smart key.

In another example, if the vehicle 10 enters a parking space in a perpendicular parking manner in a state the RSPA 2 mode is activated, but alignment has not been completed, the CLU displays a guidance message stating, “For convenient alighting, the remote forward/backward function will be executed when alighting with the smart key” or “For convenient exit, the remote forward/backward function will be executed upon exiting the vehicle while carrying the smart key”. Thereafter, if the driver alights from the vehicle 10 while holding the smart key or the smartphone, the parking control unit 120 activates the RSPA 2 remote control mode. The driver can alight and complete parking remotely using the smart key or smartphone.

As another example, when the RSPA 2 mode reaches the final stage and alignment is completed, the CLU displays a guidance message saying, “For convenient alighting, the remote forward/backward function will be executed when alighting with the smart key”. The driver may activate a forward assistance function by pressing and holding an indoor parking view button on the CLU. Thereafter, when the driver alights from the vehicle while holding the smart key or the smartphone, the parking control unit 120 activates the RSPA 2 remote control mode. Therefore, the driver can alight from the vehicle 10 and complete parking remotely using the smart key or smartphone.

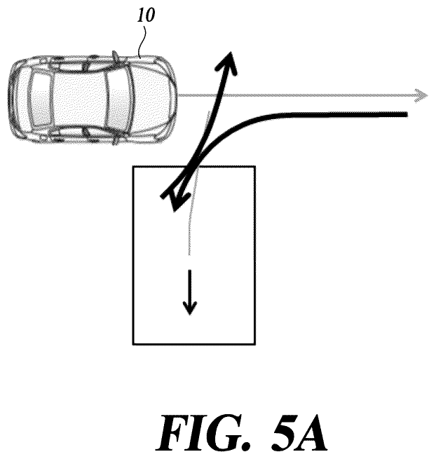

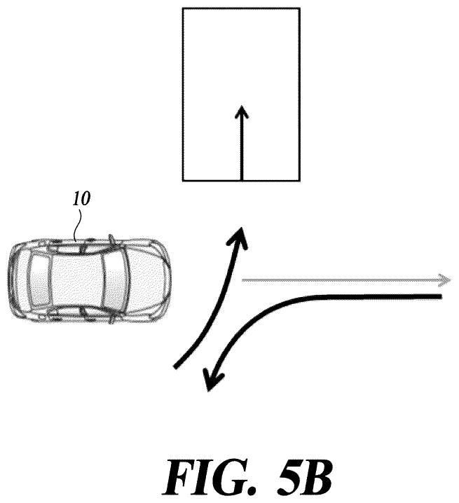

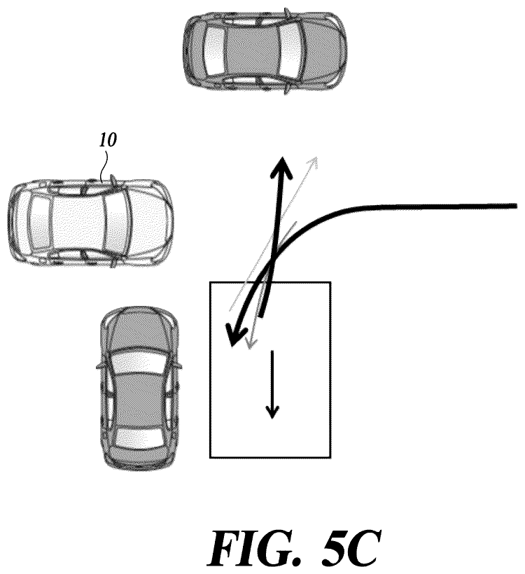

FIGS. 5A, 5B, and 5C are diagrams showing examples recognized as parking situations by the parking control unit 120 according to an embodiment of the present disclosure.

FIG. 5A illustrates a method of perpendicular reverse parking of the vehicle 10. The driver recognizes a parking space, maintains the vehicle 10 in a reverse state, and approaches the parking space by turning the steering wheel a lot. Thereafter, the driver performs an alignment process to enter the parking space by operating the steering wheel in the opposite direction. After completing the alignment, the vehicle finally enters the parking space. Thereafter, if a situation in which the vehicle 10 leaves the parking space, or the like does not occur, the parking control unit 120 activates the RSPA 2 remote control mode when the driver alights from the vehicle 10 while holding the smart key or the smartphone. Therefore, the driver can alight from the vehicle 10 and complete parking remotely using the smart key or the smartphone.

FIG. 5B illustrates a case of perpendicular forward parking of the vehicle 10. The driver recognizes a parking space, maintains the vehicle 10 in a reverse state, and approaches the parking space by turning the steering wheel a lot. Thereafter, the driver operates the steering wheel in the opposite direction to perform an alignment process for entering the parking space. After completing the alignment, the vehicle 10 finally enters the parking space. Thereafter, if a situation in which the vehicle 10 leaves the parking space, or the like does not occur, the parking control unit 120 activates the RSPA 2 remote control mode when the driver alights from the vehicle 10 while holding the smart key or the smartphone. Therefore, the driver can alight from the vehicle 10 and can complete parking remotely using the smart key or the smartphone.

FIG. 5C illustrates an example of perpendicular reverse parking of the vehicle 10 in a narrow area.

The driver recognizes a parking space, maintains the vehicle 10 in a reverse state, and approaches the parking space by turning the steering wheel a lot. Thereafter, the driver operates the steering wheel in the opposite direction to perform an alignment process to enter the parking space. In a narrow area, additional alignment may be required within the parking space. After the alignment is completed, the vehicle 10 finally enters the parking space. Thereafter, if a situation in which the vehicle 10 leaves the parking space, or the like does not occur, the parking control unit 120 activates the RSPA 2 remote control mode when the driver alights from the vehicle 10 while holding the smart key or the smartphone. Therefore, the driver can alight from the vehicle 10 and can complete parking remotely using the smart key or the smartphone.

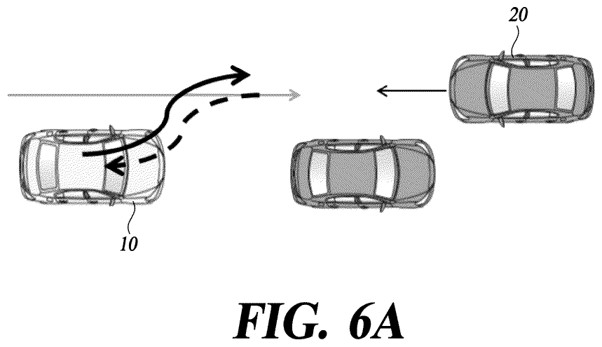

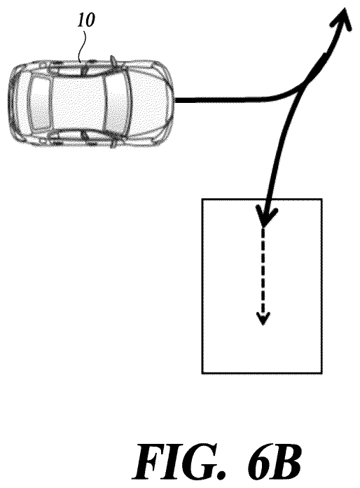

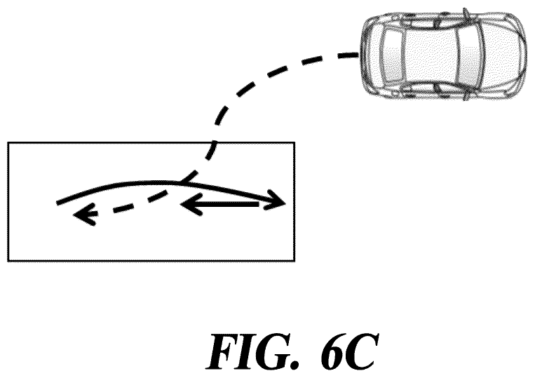

FIGS. 6A, 6B, and 6C are diagrams showing examples that are not recognized as parking situations by the parking control unit 120 according to an embodiment of the present disclosure.

FIG. 6A is a diagram illustrating a method in which the vehicle 10 avoids a collision by reversing when another vehicle 20 approaches while parking in a narrow alley.

The driver recognizes a parking space, maintains the vehicle 10 in a reverse state, and approaches the parking space by turning the steering wheel a lot (represented by a dotted line). However, because this is an operation for avoiding approach of another vehicle 20, no additional alignment occurs, and thus the parking control unit 120 does not recognize the operation as a parking situation.

FIG. 6B illustrates a method of perpendicular reverse parking of the vehicle 10.

In other words, FIG. 6B illustrates an example in which the driver recognizes a parking space, turns the steering wheel in one direction while driving straight, and then operates the steering wheel in the opposite direction to enter the parking space. However, because no additional alignment occurs, the parking control unit 120 does not recognize this situation as a parking situation.

FIG. 6C illustrates a method of parallel parking of the vehicle 10.

The driver recognizes a parking space, maintains the vehicle 10 in a reverse state, and turns the steering wheel at a large angle to approach the parking space. However, in the process of the vehicle 10 moving backward (indicated by a dotted line), the parking control unit 120 does not recognize the situation in which the driver operates the steering wheel in both directions as a parking situation.

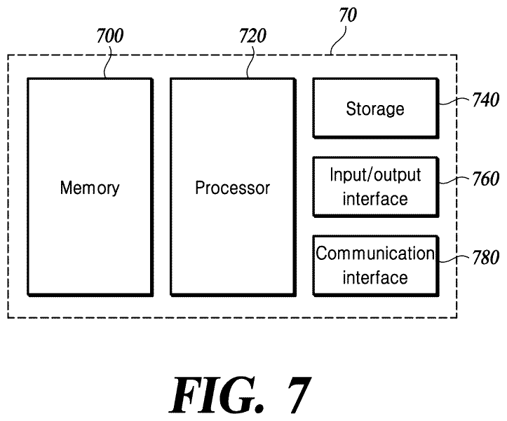

FIG. 7 is a block diagram schematically illustrating a computing device that can be used to implement a method or an apparatus according to the present disclosure.

The computing device 70 may include some or all of a memory 700, a processor 720, a storage 740, an input/output interface 760, and a communication interface 780. The computing device 70 may be a stationary computing device such as a desktop computer or a server as well as a mobile computing device, such as a laptop computer or a smartphone. The computing device 70 may include any specialized hardware accelerator capable of efficiently processing operations for an artificial intelligence model. For example, the computing device 70 may include a graphic processing unit (GPU), a tensor processing unit (TPU), or a neural processing unit (NPU).

The memory 700 may store a program that causes the processor 720 to perform a method or operation according to various embodiments of the present disclosure. For example, the program may include a plurality of instructions executable by the processor 720, and the above-described method or operation may be performed by the processor 720 executing the plurality of instructions. The memory 700 may be a single memory or a plurality of memories. In this case, information required to perform the method or operation according to various embodiments of the present disclosure may be stored in a single memory or may be divided and stored in a plurality of memories. When the memory 700 comprises a plurality of memories, the plurality of memories may be physically separated. The memory 700 may include at least one of a volatile memory or a nonvolatile memory. The volatile memory includes a static random access memory (SRAM) or a dynamic random access memory (DRAM), and the nonvolatile memory includes a flash memory or the like.

The processor 720 may include at least one core capable of executing at least one instruction. The processor 720 may execute instructions stored in the memory 700. The processor 720 may be a single processor or multiple processors.

The storage 740 maintains stored data even when power supplied to the computing device 70 is cut off. For example, the storage 740 may include a nonvolatile memory and may include storage media, such as a magnetic tape, an optical disk, and a magnetic disk. A program stored in the storage 740 may be loaded into the memory 700 before being executed by the processor 720. The storage 740 may store a file written in a programming language, and a program generated from the file by a compiler or the like may be loaded into the memory 700. The storage 740 may store data to be processed by the processor 720 and/or data processed by the processor 720.

The input/output interface 760 may provide an interface with an input device such as a keyboard or a mouse and/or an output device such as a display device or a printer. The user may trigger execution of a program by the processor 720 through the input device and/or check a processing result of the processor 720 through the output device.

The communication interface 780 may provide access to an external network. The computing device 70 may communicate with other devices through the communication interface 780, Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium, such as a read-only memory (ROM), a random access memory (RAM), a compact disc ROM (CD-ROM), magnetic tape, a floppy disk, or an optical data storage device. In addition, the computer-readable recording medium may further include a transitory medium, such as a data transmission medium. Furthermore, the computer-readable recording medium may be distributed over computer systems connected through a network, and computer-readable program code can be stored and executed in a distributive manner.

Although operations are illustrated in the flowcharts/timing charts in the present disclosure as being sequentially performed, this is merely a description of the technical idea of one embodiment of the present disclosure. In other words, those having ordinary skill in the art to which one embodiment of the present disclosure belongs may appreciate that various modifications and changes can be made without departing from the present disclosure, In other words, the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art should appreciate that various modifications, additions, and substitutions are possible, without departing from the idea and scope of the claimed invention. Therefore, embodiments of the present disclosure have been described for the sake of brevity and clarity. The scope of the technical idea of the present embodiments is not limited by the illustrations. Accordingly, those of ordinary skill should understand that the scope of the present disclosure is should not be limited by the above explicitly described embodiments but by the claims and equivalents thereof.

What is claimed is:

1. A method of recognizing a parking situation, the method comprising:
monitoring a parking situation of a vehicle;
determining whether the vehicle enters a parking space;
determining whether the vehicle is intended to be aligned with the parking space based on a determination that the vehicle enters the parking space;
determining whether the vehicle has completed an alignment with the parking space;
determining whether the vehicle leaves the parking space based on determining that the vehicle has completed the alignment with the parking space;
determining presence of an obstacle around the vehicle using a sensor based on determining that the vehicle has not left the parking space; and
activating a remote control mode of the vehicle based on determining that the vehicle has not left the parking space.

2. The method of claim 1, further comprising collecting driving data and surrounding environment data in real time before monitoring a parking situation of the vehicle.

3. The method of claim 1, further comprising determining whether the vehicle is shifted in an opposite direction before determining whether the vehicle enters the parking space.

4. The method of claim 1, further comprising determining whether gear shifting of the vehicle occurs after determining whether the vehicle is intended to be aligned with the parking space.

5. The method of claim 4, wherein determining whether the gear shifting of the vehicle occurs comprises monitoring a parking situation of the vehicle when shifting to P or N occurs.

6. The method of claim 5, wherein determining whether the gear shifting of the vehicle occurs comprises determining whether the vehicle is intended to be aligned with the parking space when shifting to D or R occurs.

7. The method of claim 1, further comprising determining whether the gear shifting of the vehicle occurs when determining that the vehicle has not completed the alignment with the parking space.

8. An apparatus comprising:
at least one memory configured to store instructions; and
at least one processor configured, by executing the instructions, to:
monitor a parking situation of a vehicle;
determine whether the vehicle enters a parking space;
determine whether the vehicle is intended to align with the parking space when the vehicle enters the parking space;
determine whether the vehicle has completed an alignment with the parking space when determining that the vehicle is intended to be aligned with the parking space;
determining whether the vehicle leaves the parking space when determining that the vehicle has completed the alignment with the parking space;
determining presence of an obstacle around the vehicle using a sensor when determining that the vehicle has not left the parking space; and
activate a remote control mode of the vehicle when determining that the vehicle has not left the parking space.

9. The apparatus of claim 8, wherein the at least one processor is further configured to collect driving data and surrounding environment data in real time before monitoring a parking situation of the vehicle.

10. The apparatus of claim 8, wherein the at least one processor is further configured to determine whether the vehicle is shifted in an opposite direction before determining whether the vehicle enters the parking space.

11. The apparatus of claim 8, wherein the at least one processor is further configured to determine whether gear shifting of the vehicle occurs after determining whether the vehicle is intended to be aligned with the parking space.

12. The apparatus of claim 11, wherein the at least one processor is further configured to monitor a parking situation of the vehicle when shifting to P or N occurs.

13. The apparatus of claim 12, wherein wherein the at least one processor is further configured to determine whether the vehicle is intended to be aligned with the parking space when shifting to D or R occurs.

14. The apparatus of claim 13, wherein the at least one processor is further configured to determine whether the gear shifting of the vehicle occurs when determining that the vehicle has not completed the alignment with the parking space.
